(19) United States
(12) Patent Application Publication
(10) Pub. No.: US 2002/0059566 A1
(43) Pub. Date: May 16, 2002

(54) Uni-level description of computer information and transformation of computer information between representation schemes

(76) Inventors: Lois M. Delcambre, Portland, OR (US); Shawn M. Bowers, Beaverton, OR (US)

Correspondence Address: IPSOLON LLP, 805 SW Broadway #2740, Portland, OR, 97205, US

(21) Appl. No.: 09/854,185

(22) Filed: May 11, 2001

Related U.S. Application Data
(60) Provisional application No. 60/228,407, filed on Aug. 29, 2000.

(51) Int. Cl. G06F 9/45

(52) U.S. Cl. 717/146

(57) ABSTRACT

A uni-level description of computer information built using basic structures or a metamodel allows model, schema, and instance information to be represented explicitly for a variety of distinct model-based representation schemes or models. Exemplary distinct representation schemes include Extensible Markup Language (XML), Resource Description Framework (RDF), developed by the World Wide Consortium, Topic Maps, and a relational database model. The uni-level description is stored in a computer readable medium and is comprised of basic structures that are instantiated to describe various models or representation schemes of interest. In one implementation, the uni-level description is expressed using triples, loosely based on RDF in one implementation. The basic structures or metamodel of the uni-level description includes or provides a basic or generic set of abstractions for information representations that are characterized as including representation schemes, schema level data, and instance level data. A transformation method for converting computer information from one representation scheme to another, from one schema to another, and, in general, for converting model, schema, or data from the computer information in a first representation scheme to model, schema, or data of a second representation scheme.

### STATEMENT REGARDING FEDERALLY FUNDED RESEARCH

This work supported in part through NSF grants IIS-98-17492, CDA-97-03218, and EIA-99-83518, and DARPA grant N66001-00-8032. The U.S. Government has a paid-up license in this invention and the right in limited circumstances to require the patent owner to license others on reasonable terms as provided for by the terms these grants.

### FIELD OF THE INVENTION

The present invention relates to representation schemes or models for computer information and in particular to a generic, uni-level description that is suitable for arbitrary computer information representation schemes and allows computer information to be transformed from one representation scheme to another.

### BACKGROUND AND SUMMARY OF THE INVENTION

Computers process information. Computer information may control how a computer operates, such as computer programs, or may be operated on by a computer, such as simple data, or may have any combination of these characteristics, such as information in the form of the Extensible Markup Language (XML). Computer information can be organized or structured according to a wide variety of structural models or representation schemes.

Examples of such representation schemes include XML, RDF (Resource Description Framework, developed by the World Wide Consortium), Topic Maps, and the relational database model used in a wide variety of database management system products where data is represented in tables and manipulated using SQL. The representation scheme for XML includes elements and attributes and permits elements to be nested. The representation scheme for RDF models information through resources and properties. The Topic Map model has been defined in several ways (e.g., ISO/IEC 13250 standard). Examples directed to the Topic Map model herein use a simple Topic Map model in which the Topic Map representation scheme includes: Topic Type, Topic Instance (often called “topic”), Topic Relation Type, Topic Relation Instance (often called “association”), Anchor Type, and Anchor Instance (often called “occurrence”). The representation scheme for relational databases represents information in tables. Each representation scheme typically has associated tools to manipulate or view information conforming to the representation scheme.

Different representation schemes are commonly suited to represent particular kinds of information. Together with its associated tool or tools, each representation scheme is typically directed to representing a particular type of computer information. For example, RDF is a graph-based model that is typically used to attach metadata to information sources on the World Wide Web portion of the Internet. Likewise, database representation schemes are used to represent database computer information that may be related or associated in multiple different ways and can be accessed and queried using SQL, a powerful tool.

Commonly, computer information in a selected representation scheme is inaccessible by a tool or viewer based on another representation scheme. This constrains the ways in which the computer information can be viewed and can limit the ability to organize, understand or interpret the information. Also, mechanisms for transforming information are often limited to a single representation scheme.

In accordance with the present invention, each representation scheme is characterized as defining an organization and structure for corresponding instance information or data. Some representation schemes (e.g., XML, RDF, and Topic Maps) optionally allow schema data to specifically define the organization or structure of the instance data (e.g., with XML DTDs; RDF schemas; and Topic Types, Association Types, and Anchor Types; respectively), and some representation schemes (e.g., most database management systems) require the use of a schema to set the organization for data.

The present invention provides a generic, uni-level description of structured, computer-based information. The uni-level description can be used to describe an unlimited number of computer information representation schemes. The uni-level description is self-describing; that is, the uni-level description includes a description of the representation scheme, a description of the schema (if there is one), and the actual data. The uni-level description can accommodate representation schemes with more than one level of schema.

The uni-level description is built using basic structures, which are the building blocks for describing arbitrary representation schemes. Two of the basic structures are construct and connector. Constructs represent the primitive components of a representation scheme (such as “element” in XML or “table” in a relational database). Connectors allow constructs to be connected or associated in relationships (such as the nesting of elements in XML or the attachment of anchors to topics in Topic Maps).

In addition, a lexical construct describes a model construct whose instances contain primitive-value types (e.g., string, integer, float, and Boolean). A special structural connector called conformance connector can specify a schema-instance relationship between constructs. There are a small number of other basic structures, such as set, list, and bag. By combining these basic structures, it is possible to describe representation schemes with arbitrarily complex structure. The basic structures of the uni-level description comprise a metamodel; that is, the basic structures are used to describe arbitrary models or representation schemes.

The uni-level description according to this invention provides a single, uniform description for structured computer information. The uni-level description explicitly includes a description of the model or representation scheme of the information, a description of all levels of schema information (if present), and all of the data or instance information. The uni-level description includes all levels of information in a single description, at a single level. This is why it is called the uni-level description.

As part of this invention, any information expressed in the uni-level description can be easily transformed into a new representation scheme. The transformation mechanism is able to convert information at the model level (e.g., where XML element types are converted to RDF classes), at the schema level (e.g., where the Student table in a database is converted to an Undergraduate element in XML), and at the data level (e.g., where persons under age 18 are converted to Children elements and persons over age 15 are converted to Employee elements). More than that, a single transformation can include transformations of all of these types.

Prior metamodel representations have been applied to representation schemes of only a single model structure. For example, other metamodel approaches have been used only to describe structural models such as the entity-relationship model, the relational model, the hierarchical model, and the various semantic data models including class diagrams of the Unified Modeling Language (UML). These other metamodel approaches have not provided transformations between structural models.

The uni-level description of this invention relaxes the model-specific requirements of prior metamodel representations. The uni-level description also relaxes the requirement in most database systems that schema be created prior to instances. The uni-level description thus allows for data that is not explicitly typed. For example, a Topic Instance can exist in a Topic Map without being associated to any type.

Additional advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram of a computer system that may be used to implement the present invention.

FIG. 2 is a schematic illustration of exemplary prior art model-based representation schemes.

FIG. 3 is a schematic illustration of how the basic structures of the uni-level description can be used to express a broad range of representation schemes.

FIG. 4 is a block diagram of the basic structures or metamodel of the uni-level description.

FIG. 5 illustrates a visual Unified Modeling Language (UML) representation of a simplified XML model.

FIG. 6 is a flow diagram illustrating a structural mapping or transformation process utilizing the uni-level description.

FIG. 7 is a diagram illustrating different exemplary mappings that can be provided in accordance with the present invention.

FIG. 8 shows an example of an inter-model mapping.

FIG. 9 illustrates a simplified Topic Map model using the UML visual representation.

FIG. 10 illustrates a Bundle-Scrap model using the UML visual representation.

FIG. 11 illustrates four mapping rules between a source Bundle-Scrap model and a target Topic Map model.

FIG. 12 illustrates an inter-schema mapping using the XML model.

FIG. 13 shows a model-to-schema mapping in which a Topic Map model is mapped to an XML DTD.

### DETAILED DESCRIPTION OF PREFERRED EMBODIMENTS

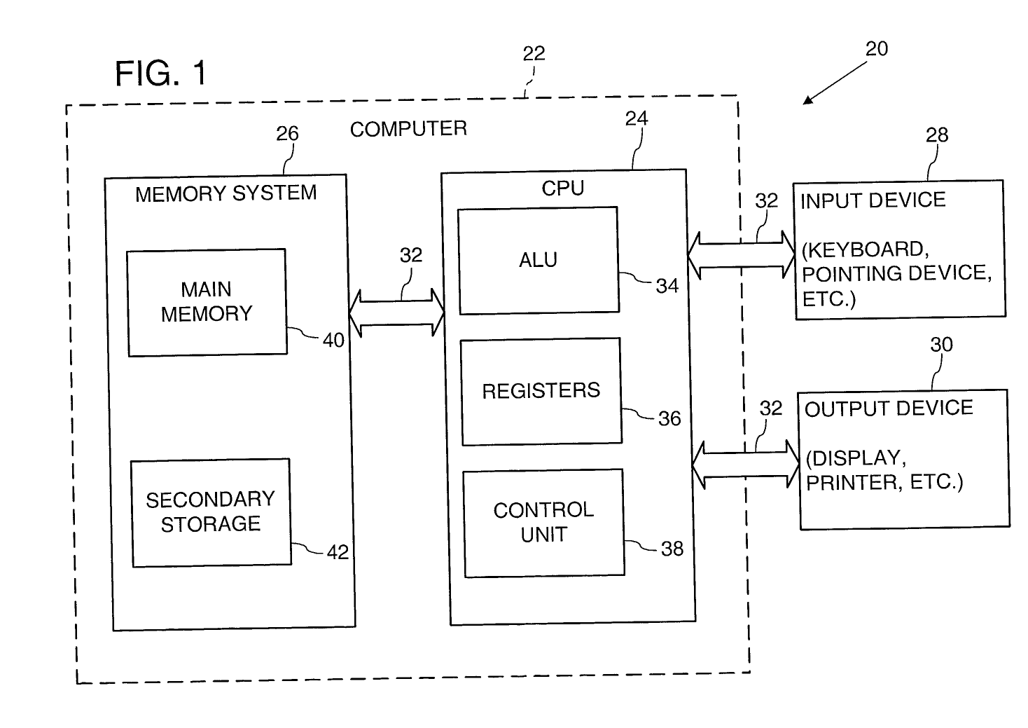

FIG. 1 illustrates an operating environment for an embodiment of the present invention as a computer system 20 with a computer 22 that comprises at least one high speed processing unit (CPU) 24 in conjunction with a memory system 26, an input device 28, and an output device 30. These elements are interconnected by at least one bus structure 32.

The illustrated CPU 24 is of familiar design and includes an ALU 34 for performing computations, a collection of registers 36 for temporary storage of data and instructions, and a control unit 38 for controlling operation of the system 20. The CPU 24 may be a processor having any of a variety of architectures including Alpha from Digital, MIPS from MIPS Technology, NEC, IDT, Siemens, and others, x86 from Intel and others, including Cyrix, AMD, and Nexgen, the PowerPC from IBM and Motorola, and the Sparc architecture from Sun Microsystems.

The memory system 26 generally includes high-speed main memory 40 in the form of a medium such as random access memory (RAM) and read only memory (ROM) semiconductor devices, and secondary storage 42 in the form of long term storage mediums such as floppy disks, hard disks, tape, CD-ROM, flash memory, etc. and other devices that store data using electrical, magnetic, optical or other recording media. The main memory 40 also can include video display memory for displaying images through a display device. Those skilled in the art will recognize that the memory 26 can comprise a variety of alternative components having a variety of storage capacities.

The input and output devices 28 and 30 also are familiar. The input device 28 can comprise a keyboard, a mouse, a physical transducer (e.g., a microphone), etc. The output device 30 can comprise a display, a printer, a transducer (e.g., a speaker), etc. Some devices, such as a network interface or a modem, can be used as input and/or output devices.

As is familiar to those skilled in the art, the computer system 20 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 26.

In accordance with the practices of persons skilled in the art of computer programming, the present invention is described below with reference to acts and symbolic representations of operations that are performed by computer system 20, unless indicated otherwise. Such acts and operations are sometimes referred to as being computer-executed and may be associated with the operating system or the application program as appropriate. It will be appreciated that the acts and symbolically represented operations include the manipulation by the CPU 24 of electrical signals representing data bits which causes a resulting transformation or reduction of the electrical signal representation, and the maintenance of data bits at memory locations in memory system 26 to thereby reconfigure or otherwise alter the computer system's operation, as well as other processing of signals. The memory locations where data bits are maintained are physical locations that have particular electrical, magnetic, or optical properties corresponding to the data bits.

Computers process information. Computer information may control how the computer operates, such as computer programs, or may be operated on by the computer, such as simple data, or may have any combination of these characteristics, such as information in the form of the Extensible Markup Language (XML). Computer information can be organized or structured according to a wide variety of structural models or representation schemes. Each representation scheme typically has associated tools to manipulate information conforming to the representation scheme.

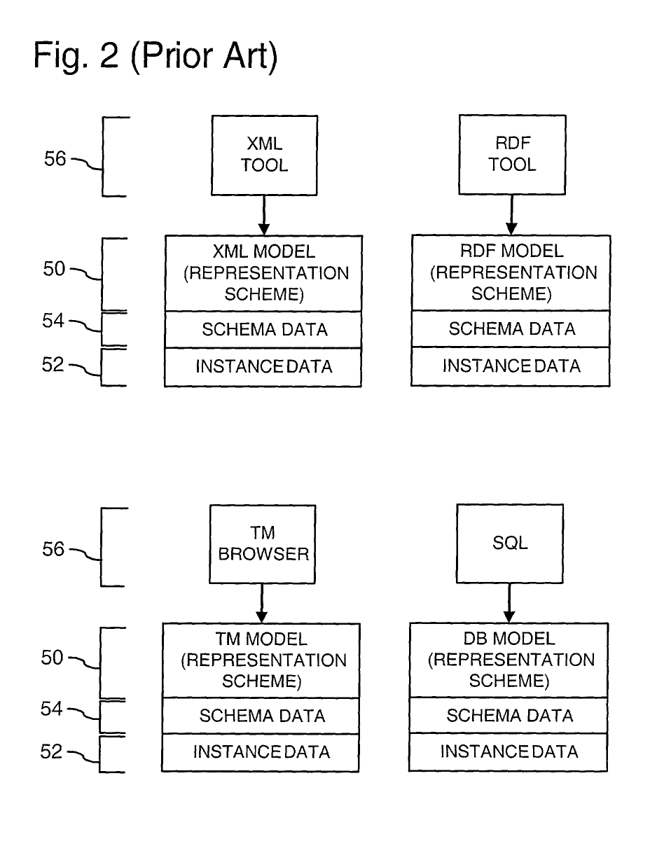

FIG. 2 is a schematic illustration of exemplary prior art representation schemes 50, such as XML, RDF (Resource Description Framework, developed by the World Wide Consortium), a simple form of Topic Maps, and an exemplary relational database model representative of a wide variety of relational database models that allow schemas to be defined and data to be inserted, queried and manipulated using SQL. For example, the representation scheme 50 for XML includes elements and attributes and permits elements to be nested, the representation scheme 50 for RDF models information through resources and properties, and the representation scheme 50 for relational databases represents information in tables.

These representation schemes are typical of structural representation schemes that can be expressed using a uni-level description according to the present invention. They are structural representation schemes in that they describe information pieces (e.g., XML elements, PCDATA content in XML, or attribute values in a relational database) and they prescribe how these information pieces can be composed or connected (e.g., through nesting of XML elements or through defining an attribute to be part of a table in a relational database). These representation schemes are typical of what are referred to herein as a model-based representation scheme.

A representation scheme is model-based when it is possible to define the structural primitives and the manner in which they can be composed. As an example, the model for the Topic Map representation scheme shown here contains Topic Instances (also known as topics), Topic Relation Instances, Anchor Instances, and so forth. Topic Relations are used to connect Topic Instances. As another example, the model for the relational database representation scheme permits tables where each table is comprised of named attributes where the table has zero or more keys and zero or more foreign keys. The model for a representation scheme is also called a data model.

The uni-level description of computer information includes a description of the model or data model for the representation scheme. The model or data model for a representation scheme is usually known, but often is not defined explicitly and is rarely represented in the same manner as the ordinary information expressed in the representation scheme.

The representation schemes shown in FIG. 2 are also typical in that there are three levels of information: one level for the model or data model as just described, one level for the schema where the structure or template for application data (or instance data or ordinary computer information) is described, and one level where the instance data or ordinary data is described. Note that a schema may be required (e.g., in a database model) or optional (e.g., in XML, RDF, and Topic Maps).

In addition, the uni-level description is capable of describing computer information that conforms to an unlimited number of such representation schemes, including but not limited to: the EXPRESS data model, semi-structured data models such as YAT and OEM, semantic data models such as the Entity Relationship model and the class diagram of the Unified Modeling Language (UML), nested relational models, object relational models such as GEM and the IBM DB2 model, hierarchical models such as IBM IMS, object-oriented models like those used in GemStone and O2, composite document models such as OpenDoc, spreadsheet models in products like Microsoft Excel®, hierarchy-based models like directory structures of file systems or LDAP, the binary data model, conceptual models as used in the Microsoft® Metadata Repository, knowledge representation models as found in KIF/KQML, the model of ASN.1, and various data interchange formats including NetCDF and CIF.

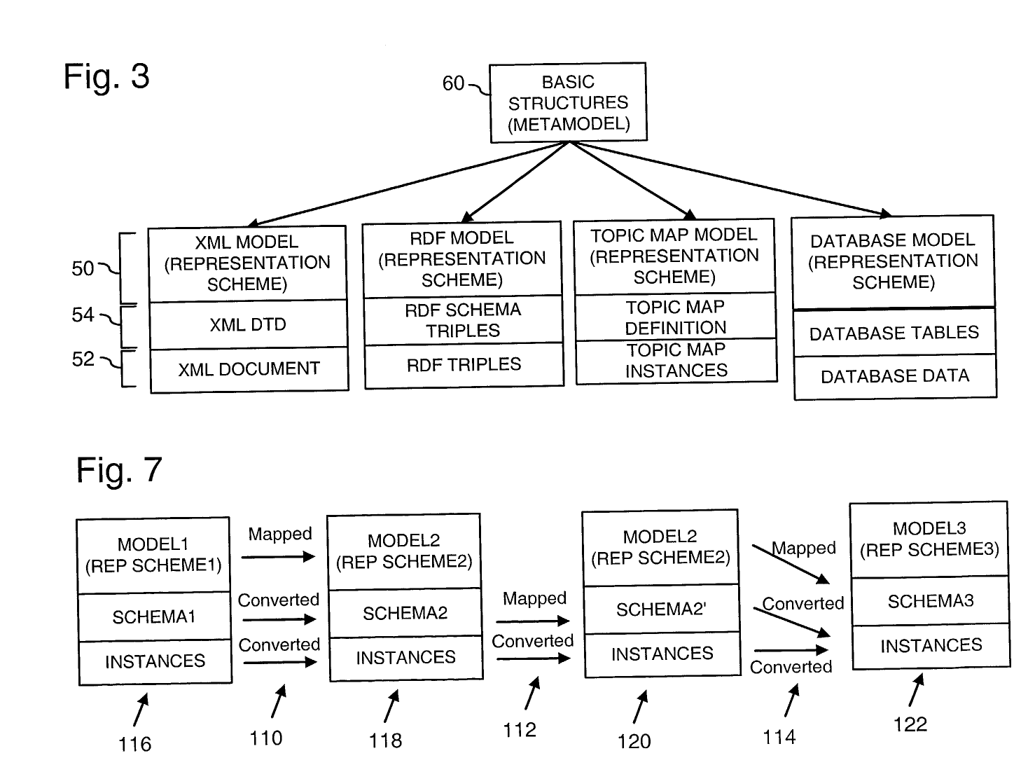

FIG. 3 is an illustration of how computer information conforming to various representation schemes can be expressed in the uni-level description of the present invention. The basic structures of the uni-level description comprise a metamodel 60 and are used to describe the model or data model of each representation scheme. This allows all schema and instance or ordinary data to be expressed in the uni-level description.

The uni-level description explicitly represents all of these kinds of information, model or data model, schema, and instance or ordinary data, in a simple uniform way. The simple uniform representation of all of these kinds of information allows them to be accessed using a conventional, database-style query language such as SQL or Datalog. The fact that the uni-level representation allows all of these kinds of information to be accessed by the query language allows such queries as “for all connectors between ‘person’ and ‘phone number,’ list all phone numbers for ‘John Smith.’” Technically, this is a second order query (asking to find all connectors) that is expressed as a simple database-style query against the uni-level description.

This uni-level description is unique in that it explicitly represents the model or data model of the representation scheme, that the uni-level description can be used to describe an unlimited number of representation schemes, that the uni-level description represents all of its kinds of information in a simple uniform way, that information with multiple levels of schema-instance connections can be directly represented in the uni-level description, that the uni-level description allows all of its information to be directly accessed using a simple, conventional database-style query language, and that information from multiple representation schemes can be freely combined, mixed, and further constrained once they have been expressed in the uni-level description. In the illustration of FIG. 3, each uni-level description of a representation scheme has three levels: model, schema, and instances. It will be appreciated, however, that the uni-level description based on basic structures or metamodel 60 would be similarly applicable to computer information comprised of instance and model data without a schema, instance and schema data without a model, model and schema data without instances, instance data without model or schema data, model data without schema or instance data, and schema data without model or instance data.

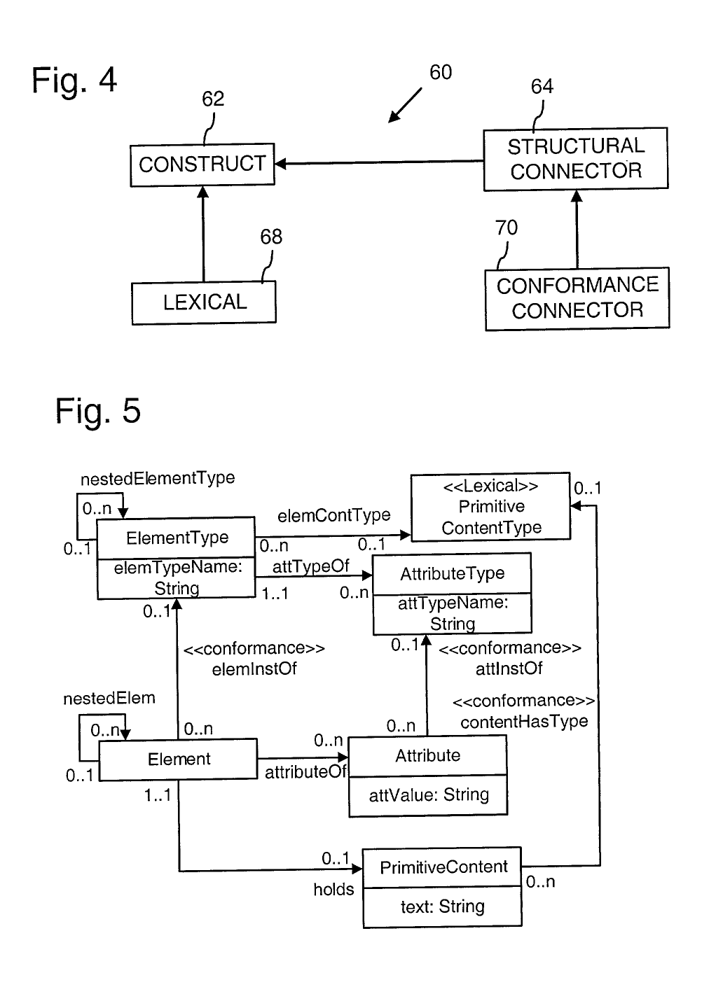

FIG. 4 is a block diagram of the basic structures or metamodel 60 of the uni-level description. Metamodel 60 includes a construct 62 that defines a structural primitive 50 and a structural connector 64 that defines a relationship between constructs 62. Construct 62 is the essential primitive of the metamodel 60. There are a small number of additional basic constructs including connector 64 and such things as list, set, or bag. The basic structures permit a very wide range of data structures and, hence, representation schemes to be described.

As illustrated, the metamodel 60 also includes a lexical construct 68. A lexical construct 68 describes a model construct with instances that contain primitive-value types (e.g., strings, integers, floats, or Boolean). A special structural connector called conformance connector 70 specifies a schema-instance relationship between constructs. As an example of the schema-instance connection expressed using conformance connector 70, a valid XML document with its associated DTD would use a conformance connector to connect an element, such as person element, to its corresponding element type, e.g., person element type.

Table 1 shows an example of the XML model 50 defined in terms of the basic structures or metamodel 60 of the uni-level description. For purposes of illustration, the XML representation scheme 50 in Table 1 has been simplified to comprise Element Types, Elements, Attribute Types, Attributes, Primitive Content Type (e.g., PCDATA), and Primitive Content along with a minimal set of relationships between them. It will be appreciated that a similar table could be formed for each representation scheme 50 to be expressed in the uni-level description.

Element constructs in XML form a hierarchy that is represented by the model connector Nested Element. By using multiplicity constraints, an Element may be specified as nested or not nested within one parent Element and can have many Elements nested within it. Conformance connectors specify schema-instance relationships between Attribute and Attribute Type, Element and Element Type, and Primitive Content and Primitive Content Type. Constraints may also be applied to the relationships. For example, by assigning the appropriate multiplicity constraints it may be specified that an instance construct cannot exist without a schema construct.

TABLE 1

| Rep- | | | | |
|---|---|---|---|---|
| resen- | | | | |
| tation | | | | Conformance |
| scheme | Constructs | Lexicals | Connectors | Connectors |
| XML | Element Type | Primitive- | Nested Element | Element |
| Model | | Content | Type- | Instance Of- |
| | | | Connects two | Connects an |
| | | | element types | element to its |
| | | | | element type |
| | Attribute Type | | Nested Element | Attribute |
| | | | -Connects two | Instance Of- |
| | | | elements | Connects an |
| | | | | attribute to its |
| | | | | attribute type |
| | Element | | Element | Content |
| | | | Content- | Instance Of- |
| | | | Connects an | Connects |
| | | | element to | primitive |
| | | | primitive | content to its |
| | | | content | primitive |
| | | | | content type |
| | Attribute | | Element | |
| | | | Content Type- | |
| | | | Connects an | |
| | | | element type to | |
| | | | primitive | |
| | | | content type | |
| | Primitive | | Element | |
| | Content Type | | Attribute- | |
| | | | Connects an | |
| | | | element to an | |
| | | | attribute | |
| | Primitive | | Attribute | |
| | Content | | Element Type- | |
| | | | Connects an | |
| | | | element type to | |
| | | | an attribute type | |

Metamodel 60 and the uni-level description are not limited to expressing information with just one schema-instance connection. Rather, the uni-level description allows representation schemes 50 to have multiple levels of schema and instance connection. In a Topic Map, for example, Topic Instances (i.e., topics) can have a type that is also a Topic Instance (topic), and it too can have a type, resulting in two (or more) levels of schema and instance definition. For example, a topic “Mary Doe” might have a type of “Person” where “Person” has a type of “Mammal” and so forth.

In one implementation, the uni-level description has a representation that is loosely based on a subset of RDF. More specifically, the uni-level description uses the notion of triple (3-tuple), which consists of a predicate (or property), a resource, and a value. In the uni-level description, a resource is represented as a character string that denotes a simple identifier (like “Element”), and a value can be either a resource or a primitive value, where a primitive value is a character string representation that holds a value whose type is a valid lexical type). In the given implementation of the uni-level description, the predicate τ is used to denote a triple in which the first argument is a predicate, the second argument a resource, and the last argument a value.

Note that the definition of triple presented above is not unique to RDF and is one of many accepted ways to represent a directed, edge-labeled graph. It will be appreciated that the triple of the uni-level description of the present invention may alternatively be represented in or by any other directed, edge-labeled graph representation.

The basic structures of this representation of the uni-level description include the following resources: Construct, Connector, Lexical, and Conformance, as well as the following properties: instanceOf, conformsTo, domainMult, rangeMult, and inverseOf. The property instanceOf is used to define representation scheme constructs and connectors as well as data. For example, XML contains the construct Element, which is defined as an instanceOf Construct and a particular element (like employee) is defined as an instanceOf Element. The conformsTo property is used to define a conformance relation between connectors (as opposed to constructs).

The domainMult and rangeMult properties can be used to specify multiplicity constraints (i.e., the number of allowable occurrences) at a connector end. A multiplicity is one of optional, required, multiple, or any, which are denoted as 0 . . . 1, 1 . . . 1, 1 . . . n, or 0 . . . n, respectively. The inverseOf property is a constraint that specifies a connector as being an inverse of another. Also, the uni-level description uses the RDF properties domain and range to denote the start and end of a connector.

Table 2 lists the resources and properties that comprise the basic structures of the uni-level description, in an implementation using triples. Table 2 also includes several default lexical constructs for purposes of convenience.

TABLE 2
The uni-level description resources, properties, and default
lexicals

| Resources | Properties | Default Lexicals |
|---|---|---|
| Construct | InstanceOf | τ(′instanceOf′, ′String′, ′Lexical′) |
| Connector | ConformsTo | τ(′instanceOf′, ′Integer′, ′Lexical′) |
| Lexical | domainMult | τ(′instanceOf′, ′Float′, ′Lexical′) |
| Conformance | rangeMult | τ(′instanceOf′, ′Boolean′, ′Lexical′) |
| | inverseOf | |

Table 3 shows an excerpt of the uni-level description for the simplified XML data model of Table 1. As an alternative to the triple-based uni-level description, FIG. 5 illustrates a corresponding visual Unified Modeling Language (UML) representation 78 of the same (simplified) XML representation scheme. UML defines a graphical notation for representing class diagrams. UML has been promulgated by the Object Management Group, a consortium that produces and maintains computer industry specifications.

TABLE 3
Excerpt of a uni-level description for the simplified XML model of
Table 1

τ(′instanceOf′, ′ElementType′, ′Construct′)
τ(′instanceOf′, ′AttributeType′, ′Construct′)
τ(′instanceOf′, ′AttributeType″, ′Construct′)
τ(′instanceOf′, ′Element′, ′Construct′)
τ(′instanceOf′, ′Attribute′, ′Construct′)
τ(′instanceOf′, ′Content′, ′Construct′)
τ(′instanceOf′, ′PrimitiveContentType′, ′Lexical′)
τ(′instanceOf′, ′elemTypeName′, ′Connector′)
τ(′domain′, ′elemTypeName′, ′ElementType′)
τ(′range′, ′elemTypeName′, ′String′)
τ(′domainMult′, ′elemTypeName′, ′0..n′)
τ(′rangeMult′, ′elemTypeName′, ′1..1′)
τ(′instanceOf’, ′nestedElemType′, ′Connector′)
τ(′domain′, ′nestedElemType′, ′ElementType′)
τ(′range′, ′nestedElemType′, ′ElementType′)
τ(′domainMult′, ′nestedElemType′, ′0..1′)
τ(′rangeMult′, ′nestedElemType′, ′0..n′)
τ(′instanceOf′, ′elemInstOf′, ′Conformance′)
τ(′domain′, ′elemInstOf′, ′Element′)
τ(′range′, ′elemInstOf′, ′ElementType′)
τ(′domainMult′, ′elmeInstOf′, ′0..n′)
τ(′rangeMult′, ′elemInstOf′, ′0..1′)
. . .

In the visual description of FIG. 5, UML classes represent constructs; UML relationships and UML class attributes represent connectors. UML attributes, which are connectors, have ranges that are restricted to lexical constructs (e.g., string or integer) and implicitly have a domain multiplicity of optional and a range multiplicity of required. UML stereotypes are used to distinguish lexicals from other constructs, and conformance connectors from other connectors. The schema-level constructs of FIG. 5 are Element Type, Attribute Type, and Primitive Content Type. The instance-level constructs are Element, Attribute, and Primitive Content. The conformance connector between Element and Element Type, Attribute and Attribute Type, and Primitive Content and Primitive Content Type specify the schema-instance relationships. An Element Type construct is allowed to contain a Primitive Content Type construct. Primitive Content Type is defined as a lexical construct, which means instances of the Primitive Content Type can be primitive types such as string, integer, or more specialized types such as PCDATA for XML. Elements that conform to the Element Type would then contain Primitive Content with the type specified by the Primitive Content Type.

Table 4 is an illustration, in an exemplary XML format, of schema data 54 and instance data 52 of Table 3. In this illustration, an “open” document type definition (DTD) is used for schema data 54 so that elements and attributes not defined in the DTD can be included in XML documents. For example, the element “rebounds” is not defined in the DTD, but the XML document is still considered to be in conformance with its schema (i.e., DTD).

TABLE 4
Example XML DTD and document

| XML DTD | <!ELEMENT league (team*)> |
|---|---|
| (Schema) | <!ELEMENT team (player*)> |
| | <!ATTLIST team teamName CDATA #REQUIRED> |
| | <!ELEMENT player (position*)> |
| | <!ATTLIST player playerName CDATA #REQUIRED> |
| | <!ELEMENT position #PCDATA> |
| XML | <league> |

| | |
|---|---|
| Document | <team teamName=“Blazers”> |

| | |
|---|---|
| (Instances) | <player playerName=“Steve Smith”/> |

<position> Guard </position>
<rebounds> 4.2 </rebounds>

</player>
<player playerName=“Rasheed Wallace”>

<position> Forward </position>
<rebounds> 5.3 </rebounds>

</player>

</team>
. . .
</league>

In Table 4, <!ELEMENT league (team*)> defines a league as an instance of an Element Type (schema construct), and <!ATTLIST team teamName CDATA #REQUIRED> defines a teamName as an instance of an Attribute Type (schema construct). Within the XML document of Table 4, <team teamName=“Blazers”> defines an instance of an Element that conforms to the team Element Type defined in the DTD, playerName in <player playerName=“Steve Smith”/> is an instance of an Attribute that conforms to the playerName Attribute Type defined in the DTD, and <rebounds>5.3</rebounds>is an instance of an Element that has no type defined in the DTD.

Table 5 shows an excerpt of schema and data expressed in the uni-level description that represents the XML DTD and document of Table 4. Notice that the uni-level description provides a uniform, “flat,” or uni-level representation of the XML representation scheme (shown in Table 3), schema, and data by representing everything with triples, and that the ordering of the triples is unimportant for correct representations.

TABLE 5
Excerpt of the uni-level representation for the XML DTD and
document of Table 4
Schema and Instance Uni-Level Triples

τ(′instanceOf′, ′player_type′, ′ElementType′)
τ(′elemTypeName′, ′player_type′, ′player′)
τ(′nestedElemType′, ′player_type′, ′position_type′)
τ(′attTypeOf′, ′player_type′, ′playerName_attr′)
τ(′instanceOf′, ′position_type′, ′ElementType′)
τ(′elemTypeName′, ′position_type′, ′position′)
τ(′instanceOf′, ′playerName_attr′, ′AttributeType′)
τ(′attTypeName′, ′playerName_attr′, ′playerName′)
τ(′instanceOf′), ′player1′, ′Element′)
τ(′elemInstOf′, ′player1′, ′player_type′)
τ(′attributeOf′, ′player1′, ′playerName1′)
τ(′nestedElem′, ′player1′, ′position1′)
τ(′nestedElem′, ′player1′, ′rebounds1′)
τ(′instanceOf′, ′playerName1′, ′Attribute′)
τ(′attInstOf′, ′playerName1′, ′playerName_attr′)
τ(′attValue′, ′playerName1′, ′Steve Smith′)
τ(′instanceOf′, ′position1′, ′Element′)
τ(′elemInstOf′, ′position1′, ′position_type′)
τ(′instanceOf′, ′rebounds1′, ′Element′)

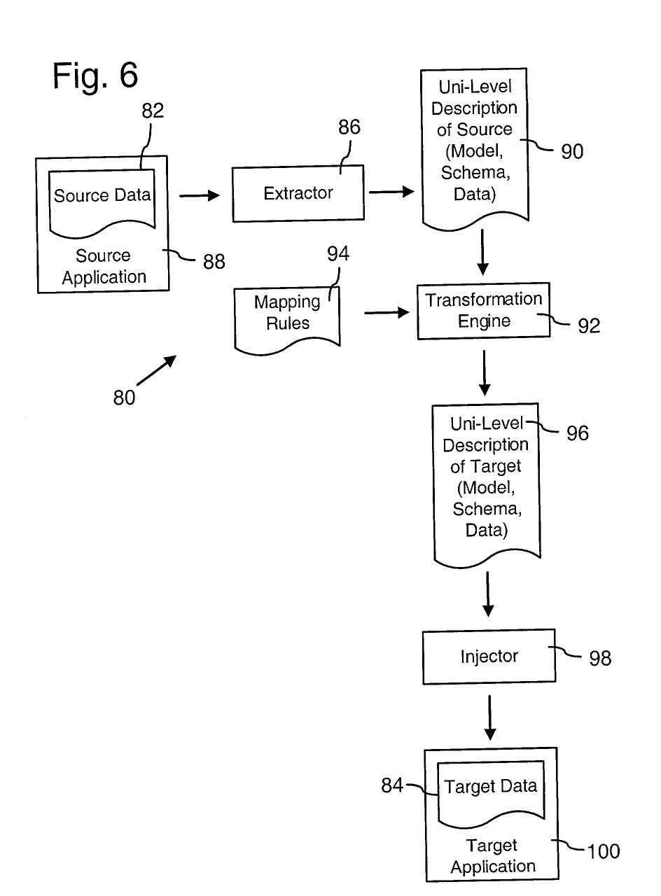

FIG. 6 is a flow diagram illustrating a process involving a mapping or transformation process 80 in which source data 82 of an originating representation scheme is transformed or mapped into target data 84 of a different representation scheme. This structural mapping process 80 is one approach that allows information to be transformed and delivered to tools that use (potentially) different models, schema, or data, thereby allowing tools adapted for one representation scheme to be used with data originally of another representation scheme. Note that the process shown in FIG. 6 can be performed in a number of ways, such as in a batch process where all source data is extracted, transformed, and injected in one step, or alternatively, in an incremental process where source data is extracted, transformed, and injected as it becomes available.

Source data 82 are extracted 86 from a source format, which might be within a source application 88, accessible through a programming interface, or located externally from the application (e.g., an XML file). In one implementation, extraction 86 of source data 82 includes conversion into the triple-based uni-level description 90. Source triples 90 include a description of the representation scheme or model 50 used by source application 88.

Source triples 90 are transformed 92 in accordance with mapping rules 94 into target triples 96 of the target uni-level description. Target triples 96 are injected 98 as target data 84 into a target application 100, such as through a programming interface or as a file stored external to the application.

Mappings are specified by a set of mapping rules, each of which are defined over the uni-level description triples. Mapping rules can be specified using a query language, or as in one implementation, through a logic-based query language such as non-recursive Datalog or pure Prolog. Note that the mappings can be implemented using a number of languages, including standard programming languages; Prolog is one such example. Mappings are not required to be complete since only part of a representation scheme, schema, or data may be needed while using a specific tool.

Table 6 lists basic definitions used to specify mappings. In the uni-level description, quotes denote constants and upper-case letters denote variables. For example, when τ(‘creator′, X, Y’) appears in a mapping rule, it matches all triples where a resource and a value are related through the property “creator,” since X and Y are variables. The predicate S, defined in Table 6, is true if its τ-predicate is in a set of triples named L. For example, S(‘xml’, τ(‘instanceOf’, ‘Element’, ‘Construct’)) would be true if there were an “Element” construct defined in a set of triples denoted “xml.” Typically, L will represent either the source or target triples.

TABLE 6
Predicate and mapping rule definitions.

| Symbol | Definition |
|---|---|
| τ | A predicate that represents a triple, for example, |
| | τ(‘instanceOf’, ‘Element’, ‘Construct’). |
| L | Denotes a set (e.g., database or file) of triples-usually the source |
| | or target set. |
| S | A predicate of the form S(L, τ) that is true (exists) of τ ε L. |
| M | A mapping that consists of a set of mapping rules. |
| m | A mapping rule (for the simple case of a single source, Lₛ, and |
| | single target, Lₜ) with the form: |
| | S(I₁, τ(a₁, b₁, c₁)), . . . ,S(Iₙτ(aₙ, bₙ, cₙ)) [symbol] |
| | S(Lₜ, τ(d₁, e₁, f₁)), . . . ,S(Lₜ, τ(dₘ, eₘ, Fₘ)) |
| | Where for 1 ≦ i ≦ n, I_{I}, ε {Lₛ, Lₜ}, |
| | a_{I}, b_{I}, and c_{I} are either constants or variables, and n ≧ 0 |
| | (n = 70 is a special case where the left side of the rule is |
| | empty, i.e., there are no S-facts); for 1 ≦ j ≦ m, dⱼ, eⱼ, |
| | and fⱼ are either constants or variables and m ≧ 1; |
| | and for all variables vε{d₁, . . ., dₘ, e₁, . . eₘ, f₁, . . ., |
| | fₘ}, v must appear in the left side of this rule |

As shown in Table 6, a mapping rule is defined as a production rule. For example, the mapping rule:

S(‘source’, τ(‘creator’, X, Y)) [symbol] S(‘target’, τ(‘owner’, X, Y)), would add a triple τ(‘owner’, X, Y) to the target set for every triple that matched τ(‘creator’, X, Y) in the source set. Therefore, if τ(‘creator’, ‘index.html’, ‘John Smith’) is a triple in the source, then the triple τ(‘owner’, ‘index html’, ‘John Smith’) will be added to the target. It will be appreciated that there is no restriction placed on the number of possible sources or targets in a mapping.

Table 7 describes a conversion function that can be used to perform mappings. The conversion function applies a set of mapping rules to source and target sets of triples and can be implemented by a transformation process 80 (FIG. 6). Conversion applies a set of mapping rules to the source and (possibly) target triple sets, and adds the resulting triples to the target triple set. In one implementation, rules (or queries) written in Datalog perform the conversion function. In another implementation, queries written in SQL perform the conversion. Note that the conversion function must create the S-facts for each τ of the source and target triple sets. Additionally, as mentioned above, conversion can be expanded to include multiple sources and multiple targets.

TABLE 7
Functions used to provide mappings

| Function | Definition |
|---|---|
| Conversion: | Conversion takes a mapping M and applies the |
| M × Lₛ × Lₜ → Lₜ′ | mapping rules of M to a source set Lₛ and a target set |
| | Lₜ (represented as S-facts), and returns the updated |
| | target set Lₜ′. Conversion implements a rule-based |
| | algorithm that computes the fixed-point of applying |
| | mapping rules to the source and target triple sets. |
| ExtractModel: | L′◖ L and L′= L₁ ∪ L₂ where: |
| L → L′ | L₁ = {t\|∃x,y and tε L and t = τ(‘instanceOf’,x, y) |
| | and y = ‘Construct’, |
| | ‘Lexical’, ‘Connector’, or ‘Conformance’} |
| | L₂ = {t\|∃p,u,v and uεL₁ and u = τ(‘instanceOf’, x, y) |
| | and tεL and |
| | t = τ(p,x,v) and y = ‘Connector’ or ‘Conformance’ |
| | and p = ‘domain,’, ‘range’, ‘domainMult’, |
| | ‘rangeMult’, ‘conformsTo’, or ‘inverseOf’}. |
| ExtractSchema: | L′◖ L and L′ = L₁ ∪ L₂ where: |
| L → L′ | L₁ = {t\|∃u,v,x and t,v,vεL and u = τ(‘instanceOf’, p, |
| | ‘Conformance’) and v = τ(p, y, z) and t = τ |
| | (‘instanceOf’, z, x)} |
| | L₂ = {t\|∃p,u,v, and tεL and u,vεL₁ and u = τ |
| | (‘instanceOf’, r, x) and v = τ(‘instanceOf’, s, y) and |
| | t = τ(p, r, s)}. |
| guid → x | A 0-ary Skolem function that returns a |
| | unique identifier x. |

Table 7 also shows the functions, defined for convenience, extract-model and extract-schema. The extract-model function can be used to extract model information from a set of triples. Similarly, the extract-schema function gathers schema information from a set of triples. The extract-schema function returns the construct instances that are at the schema-ends of conformance connectors along with the connections between the schema construct instances. These functions work for cases where there is only one level of schema and instance. It will be appreciated that similar functions could be defined to extract schema information from triples that contain multiple levels of schema instance conformance. Table 7 also includes a skolem function called guid that is used to generate unique identifiers.

In general, there will be various ways to map between information representations, depending on the user's desires and the applications of interest. Therefore, mappings are often specified by a mapping architect (i.e., a person trained in mappings). There may be cases, however, in which mapping rules can be automatically generated.

FIG. 7 shows an inter-model mapping 110, an inter-schema mapping 112, and a model-to-schema mapping 114 to illustrate different exemplary mappings that can be provided in accordance with the present invention. Inter-model mapping 110 shows information from a source set of triples 116 being mapped to a target set 118 to convert data from the source into data that conforms to the target. Likewise, inter-schema mapping 112 shows information from source set 118 being mapped to a target set 120, and model-to-schema mapping 114 shows information from source set 120 being mapped to a target set 122.

It will be appreciated that mappings 110-114 are shown together for purposes of illustration and that any of the mappings could be performed separately from the others. Moreover, although illustrated and described with regard to conversion of data, it is also possible to perform integration between triple sets, where integration combines the source and target data. The mapping rules can be used to provide mapping or integration between model, schema, and instance data.

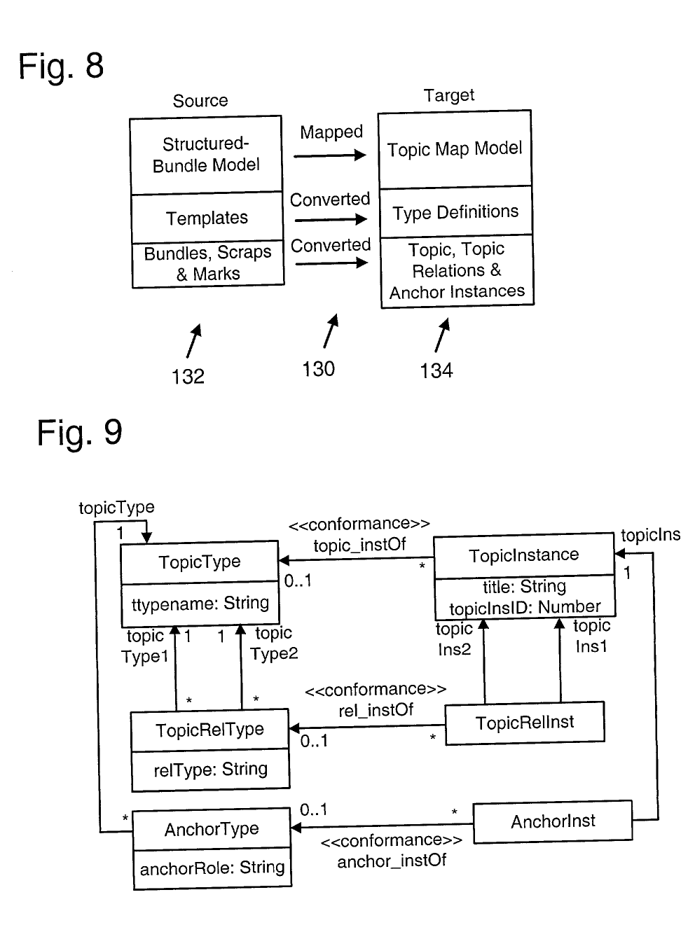

Inter-model mapping 110 shows that schema and data of the source are converted to valid schema and data of the target. FIG. 8 shows as a specific example an inter-model mapping 130 between an application-specific “Bundle-Scrap” representation scheme 132 and a simplified Topic Map representation scheme 134. As illustrated in FIG. 8, the structured-bundle model data is the highest level of source 132 that is mapped to target 134 by inter-model mapping 130. Accordingly, inter-model mapping 130 literally correlates or “maps” particular features or constructs of the structured-bundle model data with corresponding features or constructs of the Topic Map Model. Based upon this top-level literal “mapping,” lower levels of source 132 are converted to target 134 by inter-model mapping 130 based upon the correlations established by the literal mapping of the structured-bundle model data.

The Topic Map representation scheme 134 is a simplified version of the ISO standard allowing only a single level of schema and instance definition. FIG. 9 illustrates the simplified Topic Map representation scheme 134 using the UML visual representation where Topic Type, TopicRelType, and AnchorType represent the schema constructs. TopicInstance, TopicRellnst, and Anchorlnst represent the instance constructs.

The Bundle-Scrap representation scheme 132 is employed with an application called SLIMPad, which is a scratchpad application developed by the inventors of the present invention and others. Delcambre et al. Bundles in captivity: an application of superimposed information. In Proceedings of the Intentional Conference on Data Engineering (ICDE), Heidelberg, Germany, April 2001. Users interact with the SLIMPad scratchpad application by selecting content from any of a number of information sources including XML documents, graphical presentation slides (e.g., Microsoft PowerPoint), spreadsheet files (e.g., Microsoft Excel), and PDF files, and dragging the content into the scratch pad. A scrap is created for the content. The scrap contains a mark with a reference back to the content. Scraps can be organized into bundles, which can be nested. By selecting a scrap, the content referenced by the corresponding mark within the scrap is displayed and highlighted at the information source.

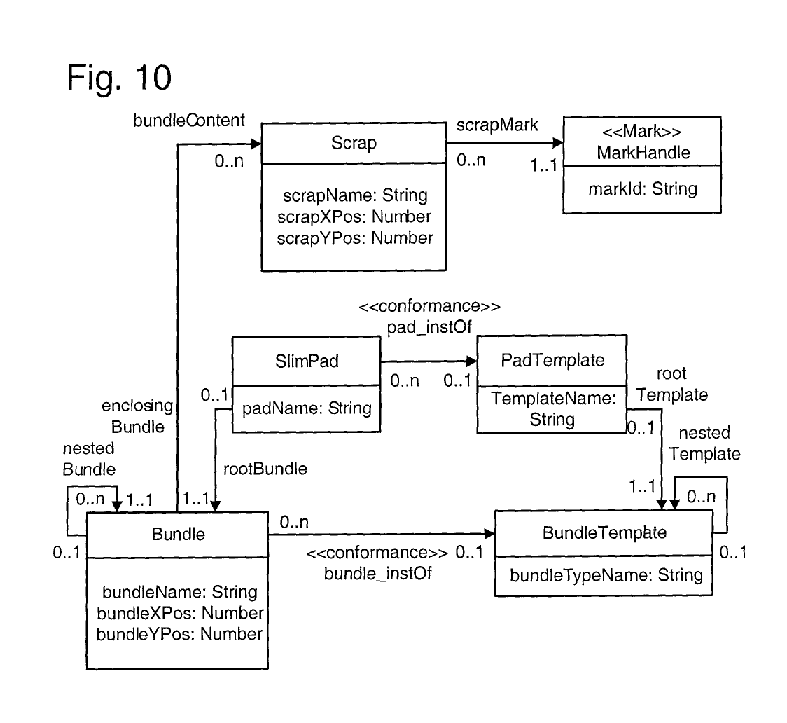

FIG. 10 illustrates the Bundle-Scrap model 132 using the UML visual representation. The Bundle-Scrap model 132 includes schema-level constructs that allow users to create and use templates to construct Bundles. By using optional multiplicity constraints, bundles can exist without an associated template (similar to an open DTD for XML).

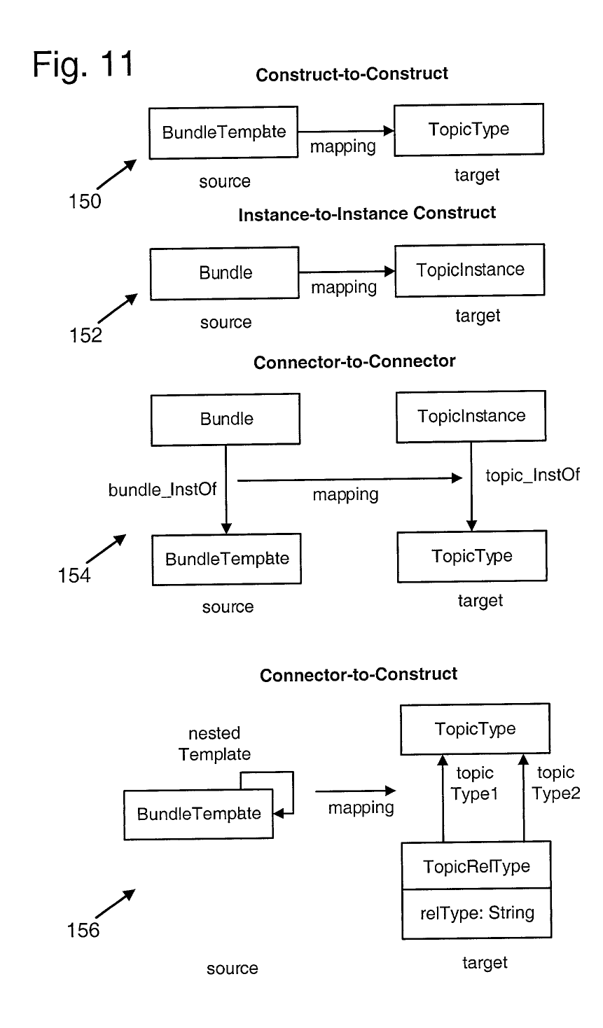

FIG. 11 illustrates four mapping rules between the source Bundle-Scrap representation scheme 132 and the target Topic Map representation scheme 134 using the UML representation. The goal of the mapping is to view SLIMPad data as if it were a Topic Map with a Topic Map browser.

A construct-to-construct mapping rule 150 specifies a mapping between the Bundle Template schema construct and the Topic Type schema construct of Topic Map model 134. All Bundle Templates in the source will be converted to Topic Types in the target as a result of this rule. An instance-to-instance construct mapping rule 152 specifies a mapping between Bundles and Topic Instances, which are both at the instance-level. A connector-to-connector mapping rule 154 specifies a mapping between two conformance connectors: bundle₁₃ instOf and topic₁₃instOf. Mapping 154 indicates that each bundle₁₃instOf relationship in the source should be converted to a topic₁₃instOf relationship in the target. A connector-to-construct mapping rule 156 shows the nestedTemplate connector being mapped to a Topic Relation Type. As the schema-level data is converted, a new Topic Relation Type instance will be created with its relType attribute set to the constant value “nested₁₃template.” Additionally, the instance from which the nestedTemplate connector originates (a Bundle Template instance) is converted to a Topic Type instance and assigned to the end of the corresponding topicType 1connector. Similarly, the instance at the end (the range side) of the NestedTemplate connector is converted to a Topic Type instance and assigned to the end of the corresponding topicType2 connector. Note that these examples illustrate only a small number of the possible mapping rules that could be employed.

Table 8 shows mapping rules that correspond to the mappings of FIG. 11. The constant ‘source’ is used to represent the Bundle-Scrap set and the constant ‘target’ to represent the new set of Topic Map triples created from the mappings.

TABLE 8
Example inter-model mappings from Bundle-Scrap to a Topic Map

| | |
|---|---|
| a. Construct to Construct | b. Instance to Instance Construct |
| S(‘source’, τ(‘instanceOf’, X, | S(‘source’, τ(‘instanceOf’, X, ‘Bundle’)) |
| ‘Bundle Template’)) | [symbol] |
| [symbol] | S(‘target’, τ(‘instanceOf’, X, ‘TopicInstance’)) |
| S(‘target’, τ(‘instanceOf’, X, ‘TopicType’)) | |
| c. Connector to Connector | d. Connector to Construct |
| S(‘source’, τ(‘bundle_instOf’, X, Y)), | S(‘source’, τ(‘nestedTemplate’, P, B)), |
| S(‘target’, τ(‘instanceOf’, X, | S(‘target’, τ(‘instanceOf’, P, ‘TopicType’)), |
| ‘TopicInstance’)), | S(‘target’, τ(‘instanceOf’, B, ‘TopicType’)), |
| S(‘target’, τ(‘instanceOf’, Y, ‘TopicType’)) | X = guid() |
| [symbol] | [symbol] |
| S(‘target’, τ(‘topic_instOf’, X, Y)) | S(‘target’, τ(‘instanceOf’, X, ‘TopicRelType’)), |
| | S(‘target’, τ(‘relType’, X, ‘nested_template’)), |
| | S(‘target’, τ(‘topicType1’, X, P)), |
| | S(‘target’, τ(‘topicType2’, X, B)) |

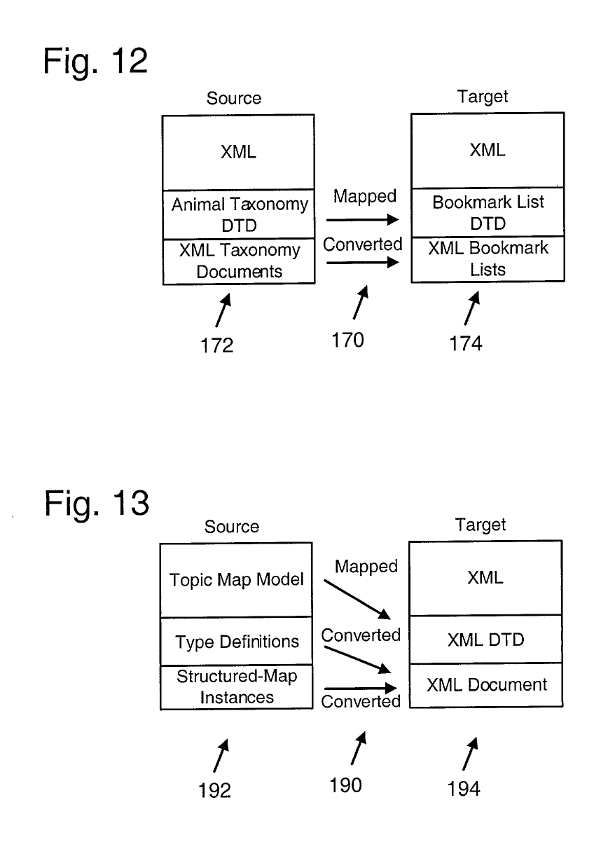

For exemplary inter-schema mapping 112 of FIG. 7, source model 118 and target model 120 are the same, but two distinct schemas are mapped so that the source instance data can be converted to target data that conforms to target schema 120. FIG. 12 illustrates an inter-schema mapping 170 using the XML model. Mapping 170 has a source 172 that is an animal taxonomy DTD containing Element Types such as genus and species. A target 174 is a bookmark list DTD with Element Types such as folder and bookmark. One reason to perform this type of mapping might be to use an existing tool for browsing bookmark lists on the taxonomy data.

As illustrated in FIG. 12, the Animal Taxonomy DTD schema data is the highest level of source 172 that is mapped to target 174 by inter-schema mapping 170. Accordingly, inter-schema mapping 170 literally correlates or “maps” particular features or constructs of the Animal Taxonomy DTD schema data with corresponding features or constructs of the Bookmark List DTD. Based upon this top-level literal “mapping,” the lower level of source 172 is converted to target 174 by inter-schema mapping 170 based upon the correlations established by the literal mapping of the Animal Taxonomy DTD schema data.

Table 9 demonstrates three rules that may be used to perform part of mapping 170.

TABLE 9
Example inter-schema mapping rules, source and target
schema, source document, and result

```
Source Schema
τ(‘instanceOf’, ‘genus_type’, ‘ElementType’)
τ(‘elementTypeName’, ‘genus_type’, ‘genus’)
τ(‘instanceOf’, ‘species_type’, ‘ElementType’)
τ(‘elementTypeName’, ‘species_type’, ‘species’)
τ(‘nestedElementType’, ‘genus_type’, ‘species_type’)
τ(‘instanceOf’, ‘name_attType’, ‘AttributeType’)
τ(‘attTypeName’, ‘name_attType’, ‘name’)
τ(‘attTypeOf’, ‘genus_type’, ‘name_attType’)
τ(‘attTypeOf’, ‘species_type’, ‘name_attType’)
Target Schema
τ(‘instanceOf’, ‘folder_type’, ‘ElementType’)
τ(‘elementTypeName’, ‘folder_type’, ‘folder’)
τ(‘nestedElementType’, ‘folder_type’, ‘folder_type’)
τ(‘nestedElementType’, ‘folder_type’, ‘folder_type’)
τ(‘instanceOf’, ‘title_attType’, ‘AttributeType’)
τ(‘attTypeOf’, ‘folder_type’, ‘title_attType’)
τ(‘attTypeName’, ‘title_attType’, ‘title’)
Source Document Excerpt
  <genus name=“Homos”>
  <species name=“Sapiens”>
  . . .
  </species>
  . . .
  </genus>
Example Mapping Rules
S(‘source’, τ(‘elemInstOf’, X, ‘genus_type’) ),
S(‘source’, τ(‘attributeOf’, X, A)),
S(‘source’, τ(‘attInstOf’, A, ‘name_attType’)),
S(‘source’, τ(‘attValue’, A, T))

[symbol]

S(‘target’, τ(‘elemInstOf’, X, ‘folder_type’)),
S(‘target’, τ(‘attInstOf’, A, ‘title_attType’)),
S(‘target’, τ(‘attributeOf’, X, A)),
S(‘target’, τ(‘attValue’, A, T))
S(‘source’, τ(‘elemInstOf’, X, ‘species_type’)),
S(‘source’, τ(‘attributeOf’, X, A)),
S(‘source’, τ(‘attInstOf’, A, ‘name_attType’)),
S(‘source’, τ(‘attValue’, A, T))

[symbol]

S(‘target’, τ(‘elemInstOf’, X, ‘folder_type’)),
S(‘target’, τ(‘attInstOf’, A, ‘title_attType’)),
S(‘target’, τ(‘attributeOf’, X, A)),
S(‘target’, τ(‘attValue’, A, T)),
S(‘source’, τ(‘nestedElementType’, X, Y) )

[symbol]

S(‘target’, τ(‘nestedElementType’, X, Y))
Excerpt of Converted Source Docment
<folder title=“Homos”>
  <folder title=“Sapiens”>
    . . .
  </folder>
    . . .
  </folder>
```

The first two mapping rules select genus and species elements along with their name attributes and maps them to a folder with the appropriate title (e.g., titled “homos” or “sapiens”). The last rule keeps the source document's nested structure, so species elements (e.g., the sapiens elements) are mapped as nested folders within their appropriate genus folders. The source and result of the conversion is also shown in Table 9.

FIG. 13 shows a model-to-schema mapping 190 (an example of mapping 114 of FIG. 7) in which a Topic Map model 192 is mapped to an XML DTD 194. Model 192 of the source is mapped to schema data in the target, which allows the schema and instance data of the source to be converted to valid instance data in the target. The Topic Map schema and instance data are converted to an XML document. One benefit of this mapping would be to use XML as the interchange format for Topic Maps.

More specifically, the Topic Map Model data is the highest level of source 192 that is mapped to target 194 by model-to-schema mapping 190. Accordingly, model-to-schema mapping 190 literally correlates or “maps” particular features or constructs of the Topic Map Model data with corresponding features or constructs of the XML DTD. Based upon this top-level literal “mapping,” the lower levels of source 192 are converted to target 194 by model-to-schema mapping 190 based upon the correlations established by the literal mapping of the Topic Map Model data.

To specify the mapping, a Topic Instance construct in the Topic Map model is mapped to an Element Type in an XML DTD with an Attribute Type titled “name”. For a particular Topic Instance (e.g., “van Gogh”), a conversion results in the XML tag <topic name=“van Gogh”/>. Table 10 shows two rules to perform a portion of the mapping.

TABLE 10

Excerpt of the Source Model, Expressed in Triples:
S(‘source’, τ(‘instanceOf’, ‘TopicInstance’, ‘Construct’))
S(‘source’, τ(‘instanceOf’, ‘title’, ‘Connector’))
S(‘source’, τ(‘instanceOf’, ‘t1’, ‘TopicInstance’))
S(‘source’, τ(‘title’, ‘t1’, ‘painter’))
Example Mapping Rules:

[symbol]

S(‘target’, τ(‘instanceOf’, ‘topic_Inst’, ‘ElementType’)),
S(‘target’, τ(‘elemTypeName’, ‘topic_inst’, ‘topic’)),
S(‘target’, τ(‘instanceOf’, ‘topicInst_att’, ‘AttributeType’)),
S(‘target’, τ(‘attTypeName’, ‘topicInst_att’, ‘name’)),
S(‘target’, τ(‘attTypeOf’, ‘topic_isnt’, ‘topicInst_att’))
S(‘source’, τ(‘instanceOf’, X, ‘TopicInstance’)),
S(‘source’, τ(‘title’, X, Y))

[symbol]

S(‘target’, τ(‘instanceOf’, X, ‘Element’)),
S(‘target,’, τ(‘elemInstOf’, X, ‘topic_inst’)),
A = guid(),
S(‘target’, τ(‘instanceOf’, A, ‘Attribute’)),
S(‘target’, τ(‘attName’, A, ‘name’)),
S(‘target’, τ(‘attInstOf’, A, ‘topicInst_Att’)),
S(‘target’, τ(‘attributeOf’, X, A)),
S(‘target’, τ(‘attValue’, A, Y))

The left side of the first rule in Table 9 is empty. Rules without left sides automatically match, which means that the right side triples are always added to the target. A model-to-schema mapping is only one example of mapping between levels. In general, no limitation is imposed on the types of mappings that can be specified within a set of mapping rules. For any mapping between source and target, there may be any combination of mapping rules that are model-to-model, schema-to-schema, and data-to-data.

Having described and illustrated the principles of our invention with reference to an illustrated embodiment, it will be recognized that the illustrated embodiment can be modified in arrangement and detail without departing from such principles. For example, uni-level descriptions and mappings or transformations using the uni-level descriptions need not be applied to all of the computer information in a source representation scheme. Uni-level descriptions may be applied only to selected portions of a source representation scheme. The uni-level description may omit part or all of the model triples, part or all of the schema triples, or part or all of the data triples. Similarly, a mapping may map only some parts or types of the data. For example, FIG., 12 illustrates mapping 170 as not being applied to the top-level XML model data. Hence, uni-level descriptions and mappings or transformations may be useful even if the representation schemes are the same.

In the above examples above, the uni-level descriptions and mappings or transformations are described with reference to a single source representation scheme and a single target representation scheme. It will be appreciated, however, information from plural representation schemes (or the same representation schemes) can be freely mixed together, or integrated, or placed in a single file or information set, once both expressed in the uni-level description. Similarly, mappings or transformations can be a mix of any or all of the various kinds of mapping rules, or may include mapping rules that look for or create data of two or three kinds.

It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a computer system with selected computer information conforming to a first representation scheme having a first model structure, a representation scheme transformation method for transforming the selected computer information into a second representation scheme having a second model structure, comprising:
expressing the selected computer information in a uni-level description using basic structures that represent the selected computer information with reference to a generic set of abstractions applicable to representation schemes having different model structures; and
transforming the selected computer information expressed in the uni-level description to the second representation scheme.

2. The method of claim 1 in which the basic structures include construct elements and structural connector elements, wherein the structural connector elements connect construct elements.

3. The method of claim 2 in which the basic structures further include a lexical element that describes a model construct with instances that contain primitive-value types.

4. The method of claim 2 in which the basic structures further include a conformance connector that specifies a schema-instance relationship between constructs.

5. The method of claim 1 in which the basic structures of the uni-level description have plural generic elements, including construct elements and structural connector elements, and wherein expressing the selected computer information in the uni-level description includes forming triples to represent the uni-level description.

6. The method of claim 1 further comprising characterizing portions of the selected computer information as model constructs, schema data, or instance data.

7. The method of claim 1 in which the first and second model structures are the same.

8. The method of claim 1 in which the first and second model structures are different.

9. The method of claim 1 in which the first and second representation schemes are each one of an extensible markup language model, a resource definition framework model, a topic map model, and a database model.

10. In a computer system with selected computer information conforming to a first representation scheme that includes first model data, first schema data, and first instance data, a representation scheme transformation method for transforming the selected computer information into a second representation scheme with second model data, second schema data, and second instance data, comprising:
expressing the selected computer information in a uni-level description using basic structures that include construct elements and structural connector elements that connect construct elements, the construct elements and structural connector elements being applicable to representation schemes having different model structures; and
transforming the selected computer information expressed in the uni-level description to the second representation scheme.

11. The method of claim 10 in which the first model data of the first representation scheme are transformed into the second model data of the second representation scheme.

12. The method of claim 11 in which the model data of the first and second representation schemes are different.

13. The method of claim 10 in which the first schema data of the first representation scheme are transformed into the second schema data of the second representation scheme.

14. The method of claim 10 in which the first model data of the first representation scheme are transformed into the second schema data of the second representation scheme.

15. The method of claim 10 in which any of the first model data, first schema data, and first instance data are transformed into any of the second model data, second schema data, and second instance data.

16. The method of claim 10 in which any two or more of the first model data, first schema data, and first instance data are transformed into any of the second model data, second schema data, and second instance data.

17. The method of claim 10 in which the basic structures further include a lexical element that describes a model construct with instances that contain primitive-value types.

18. The method of claim 10 in which the basic structures further include a conformance connector that specifies a schema-instance relationship between constructs.

19. The method of claim 10 in which expressing the selected computer information in the uni-level description includes forming triples that comprise basic structure elements and the selected computer information.

20. The method of claim 10 in which the first and second representation schemes are each one of an extensible markup language model, a resource definition framework model, a topic map model, and a database model.

21. A computer readable medium having stored thereon a uni-level description of a first representation scheme that includes any of first model data, first schema data, and first instance data, comprising:
basic structures that include construct elements and structural connector elements that connect construct elements, the basic structures expressing any of the first model data, first schema data, and first instance data and being applicable to representation scheme having different model structures,

22. The medium of claim 21 in which the basic structures further include a lexical element that describes a model construct with instances that contain primitive-value types.

23. The medium of claim 21 in which the uni-level description is represented as triples with the basic structure elements and the selected computer information.

24. The medium of claim 21 in which the basic structures express all of the first model data, first schema data, and first instance data.

25. The medium of claim 21 in which the basic structures further include a conformance connector that specifies a schema-instance relationship between constructs.

26. The medium of claim 21 in which the first representation scheme is one of an extensible markup language model, a resource definition framework model, a topic map model, and a database model.

27. In a computer readable medium of a computer system with selected computer information conforming to a first representation scheme having a first model structure, representation scheme transformation software for transforming the selected computer information into a second representation scheme having a second model structure, comprising:
software for expressing the selected computer information in a uni-level description using basic structures that represent the selected computer information with reference to a generic set of abstractions applicable to representation schemes having different model structures; and
software for transforming the selected computer information expressed in the uni-level description to the second representation scheme.

28. The medium of claim 27 in which the basic structures include construct elements and structural connector elements that connect construct elements.

29. The medium of claim 27 in which the basic structures of the uni-level description have plural generic elements, including construct elements and structural connector elements, and wherein the software for expressing the selected computer information in the uni-level description includes software for forming triples to represent the uni-level description.

30. The medium of claim 27 in which the first and second model structures are the same.

31. The medium of claim 27 in which the first and second model structures are different.

32. In a computer readable medium of a computer system with selected computer information conforming to a first representation scheme that includes first model data, first schema data, and first instance data, representation scheme transformation software for transforming the selected computer information into a second representation scheme that includes second model data, second schema data, and second instance data, comprising:
software for expressing the selected computer information in a uni-level description using basic structures that include construct elements and structural connector elements that connect construct elements, the construct elements and structural connector elements being applicable to representation schemes having different model structures; and
software for transforming the selected computer information expressed in the uni-level description to the second representation scheme.

33. The medium of claim 32 in which any of the first model data, first schema data, and first instance data are transformed into any of the second model data, second schema data, and second instance data.

34. The medium of claim 32 in which any two or more of the first model data, first schema data, and first instance data are transformed into any of the second model data, second schema data, and second instance data.

35. The medium of claim 32 in which the software for expressing the selected computer information in the uni-level description includes software for forming triples that comprise basic structure elements and the selected computer information.

36. A computer readable medium of a computer system, comprising:
selected computer information conforming to a first representation scheme having a first model structure; and
uni-level description software for expressing the selected computer information in a uni-level description using basic structures that represent the selected computer information with reference to a generic set of abstractions applicable to representation schemes having different model structures.

37. The medium of claim 36 in which the basic structures include construct elements and structural connector elements that connect construct elements.

38. The medium of claim 36 in which the basic structures of the uni-level description have plural generic elements, including construct elements and structural connector elements, and wherein expressing the selected computer information in the uni-level description includes forming triples to represent the uni-level description.

39. A computer readable medium of a computer system, comprising:
selected computer information conforming to a first representation scheme that includes first model data, first schema data, and first instance data; and
uni-level description software for expressing the selected computer information in a uni-level description using basic structures that include construct elements and structural connector elements that connect construct elements, the construct elements and structural connector elements being applicable to representation schemes having different model structures.

40. The medium of claim 39 in which expressing the selected computer information in the uni-level description includes forming triples that comprise basic structure elements and the selected computer information.
